(19) United States
(12) Patent Application Publication
(10) Pub. No.: US 2019/0160677 A1
(43) Pub. Date: May 30, 2019

(54) Method Of Building A Geometric Representation Over A Working Space Of A Robot

(71) Applicant: ABB Schweiz AG, Baden (CH)

(72) Inventor: Morten STRANDBERG, Västerås (SE)

(21) Appl. No.: 16/312,684

(22) PCT Filed: Jun. 21, 2016
(86) PCT No.: PCT/EP2016/064275

§ 371 Date: Dec. 21, 2018

(51) Int. Cl. B25J 9/16; B25J 19/02; G06F 16/901

(52) U.S. Cl. CPC B25J 9/1666; B25J 9/1676; G06F 16/9027; B25J 19/023; B25J 9/163; B25J 9/1697

(57) ABSTRACT

A method of building a geometric representation over a working space of a robot is provided. The method is performed in a control device and includes: representing the working space by a three-dimensional structure, obtaining information on a trajectory in the working space travelled by the robot as being collision free, determining, based on the obtained information on the collision free trajectory and on information on geometry of the robot, a volume in the working space to be free space, the volume corresponding to the geometry of at least a part of the robot having travelled along the trajectory, and updating the three-dimensional structure by indicating the determined volume of the three-dimensional structure as free space.

### TECHNICAL FIELD

The technology disclosed herein relates generally to the field of robotics, and in particular to a method of building a geometric representation over a working space of a robot, to a control device, a computer program and computer program products.

### BACKGROUND

Collaborative robots can be used in various applications, for instance, for pre-processing, for assembly and for packaging of products such as low voltage products, digital cameras, watches, toys etc. The robots may in principle perform the same work as a skilled assembly worker, and the robots highly facilitate and improve, for instance, such assembly automation.

Models of an environment in which the robot is to work are valuable as a tool for controlling its movements, and required if the robot is to move autonomously. To this end Computer-Aided Design (CAD) tools are often used and relied upon for providing such models. However, in order to use functionality such as Collision Prediction and Collision-free Path Planning to their full potential the user of the robot has to provide detailed models of the environment.

To assume that the user of the robot has detailed CAD-models of the complete environment in which the robot is to work puts unnecessary burden on her or him. For instance, CAD-models might not be available, may be too inaccurate or the environment might change from one day to another. Further, many users find it cumbersome to load CAD-models into computer software for simulation and offline programming, and then to further convert them to Collision Avoidance models.

### SUMMARY

In view of the above, it is an objective of the present invention to provide an improved way of creating models of the working environment of the robot. This objective and others are achieved by the method, devices, computer programs and computer program products according to the appended independent claims, and by the embodiments according to the dependent claims.

The objective is according to an aspect achieved by a method of building a geometric representation over a working space of a robot. The method is performed in a control device and comprises: representing the working space by a three-dimensional structure, obtaining information on a trajectory in the working space travelled by the robot as being collision free, determining, based on the obtained information on the collision free trajectory and on information on geometry of the robot, a volume in the working space to be free space, the volume corresponding to the geometry of at least a part of the robot having travelled along the trajectory, and updating the three-dimensional structure by indicating the determined volume of the three-dimensional structure as free space.

The method provides several advantages. For instance, the end user does need not have CAD-models of the working space, and there is no need to convert such CAD-models to Collision-models. The method highly facilitates the creation of a representation of the surroundings as the robot itself is simply used. The created model may serve as a memory over places where the robot has been before so that it can remember which areas are free of collision. If the model is continually updated, it will be more and more refined.

In an embodiment, the method comprises repeating the obtaining, determining and updating for a number N of trajectories, N being equal to or more than one.

In an embodiment, the obtaining information comprises receiving information from at least one sensor (e.g. axis-position sensor) arranged on the robot and having moved from a start position to an end position of the trajectory. This is a convenient way of obtaining the information.

In an embodiment, the method comprises: receiving information about the working space from a camera, and obtaining, based on the received information, a second three-dimensional representation of at least part of the working space.

In a variation of the above embodiment, the method comprises using the second three-dimensional representation for finding a trajectory in the working space to be travelled by the robot.

In various embodiments, the three-dimensional structure comprises an octree data structure. The resulting representation of the working space is then an octree structure, which is a recursive and hierarchical block representation of the working space.

In various embodiments, the method comprises obtaining information on a trajectory travelled by the robot as encountering a collision, and indicating, based on the obtained information, a volume of the three-dimensional structure as occupied space.

The objective is according to an aspect achieved by a computer program for a control device for building a geometric representation over a working space of a robot. The computer program comprises computer program code, which, when executed on at least one processor on the control device causes the control device to perform the method according to any of above embodiments.

The objective is according to an aspect achieved by a computer program product comprising a computer program as above and a computer readable means on which the computer program is stored.

The objective is according to an aspect achieved by a control device for building a geometric representation over a working space of a robot. The control device is configured to: represent the working space by a three-dimensional structure, obtain information on a trajectory in the working space travelled by the robot as being collision free, determine, based on the obtained information on the collision free trajectory and on information on geometry of the robot, a volume in the working space to be free space, the volume corresponding to the geometry of at least a part of the robot having travelled along the trajectory, and update the three-dimensional structure by indicating the determined volume of the three-dimensional structure as free space.

In an embodiment, the control device is configured to repeat the obtaining, determining and updating for a number N of trajectories, N being equal to or more than one (i.e. at least one trajectory).

In an embodiment, the control device is configured to obtain the information by receiving information from at least one sensor arranged on the robot and having moved from a start position to an end position of the trajectory.

In an embodiment, the control device is configured to: receive information about the working space from a camera, and obtain, based on the received information, a second three-dimensional representation of at least part of the working space.

In an embodiment, the control device is configured to use the second three-dimensional representation for finding a trajectory in the working space to be travelled by the robot.

In an embodiment, the control device is configured to obtain information on a trajectory travelled by the robot as encountering a collision, and to indicate, based on the obtained information, a volume of the three-dimensional structure as occupied space.

Further features and advantages of the embodiments of the present invention will become clear upon reading the following description and the accompanying drawings.

### BRIEF DESCRIPTION OF THE DRAWINGS

FIG. 1 illustrates schematically a working space of a robot in which embodiments according to the present invention may be implemented.

FIG. 2 is a flow chart over steps of an embodiment of a method in a control device in accordance with the present invention.

FIG. 3 illustrates schematically a control device and means for implementing embodiments in accordance with the present invention.

FIG. 4 illustrates an exemplary representation of an environment using the method in accordance with the present invention.

### DETAILED DESCRIPTION

In the following description, for purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail. Same reference numerals refer to same or similar elements throughout the description.

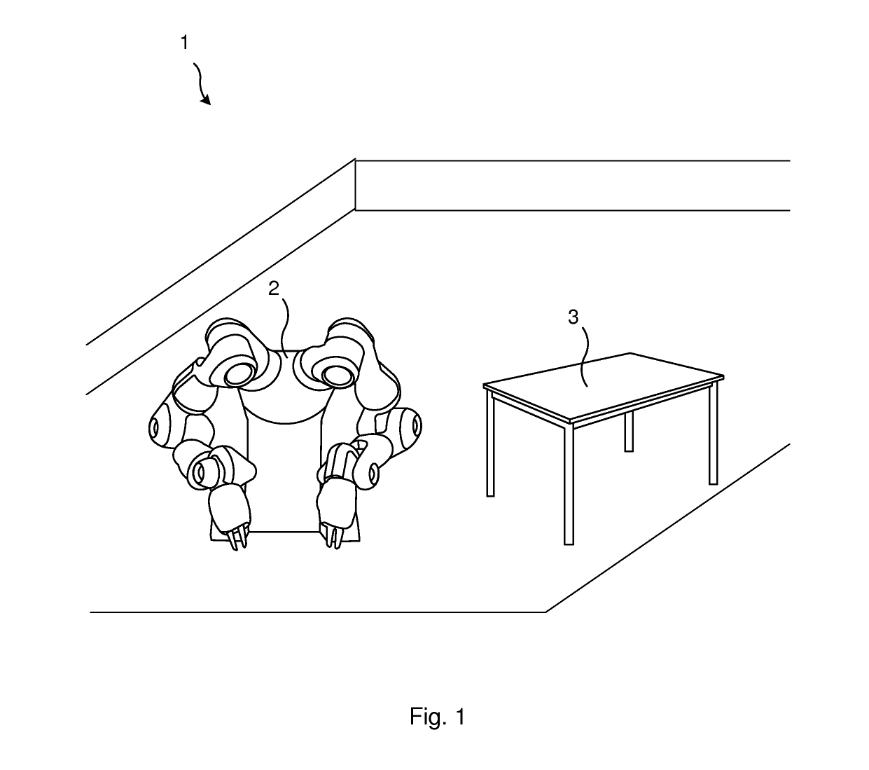

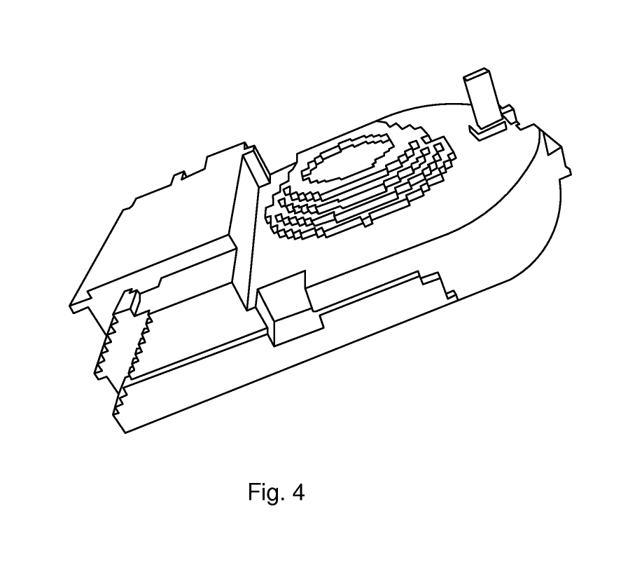

FIG. 1 illustrates schematically a working space 1 of a robot 2 in which embodiments according to the present invention may be used. The working space 1 of the robot 2 may, for instance, be an industrial environment and typically comprises a number of moving or stationary objects 3 which the robot 2 has to avoid colliding with. The robot 2 may be controlled by a control device 25 comprising various control functions, such as means for instructing the robot 2 about its movements, path planning and collision avoidance. The control device 25 is described more in detail with reference to FIG. 3.

The inventor of the present invention envisaged an ideal situation to be that the robot 2 itself senses its environment and builds its own representation of it. The use of three dimensional (3D) cameras for building a 3D representation of the environment may be seen as a step in that direction. Briefly, the invention provides a method to build a geometric representation of the robot's environment using, in some embodiments, only the robot itself. The robot 2 is used as a ‘sensor’ to build a model of the environment in which it is to work, i.e. of its working space 1 (also known as work cell). In some embodiments, this approach is advantageously combined with a 3D camera. The provided method greatly reduces the efforts required by the end user of the robot for creating the model of the working space 1.

The invention takes advantage of the fact that precise knowledge of the robot's geometry and its current position are available. Given a trajectory, the robot's geometry will sweep out a volume in its workspace. Assuming that the movement that the robot made is collision-free, then the corresponding entire volume that is swept out can be marked as free. The robot may be seen as starting with a world representation where the entire world is occupied by a single solid three-dimensional structure, e.g. a cube. By doing collision-free movements, free space is being ‘carved out’ from this cube. If the exploratory movements cover the working space 1 that the robot 2 needs, then the resulting model of the free space will be sufficient for tasks like Collision Prediction and Collision-free Path Planning.

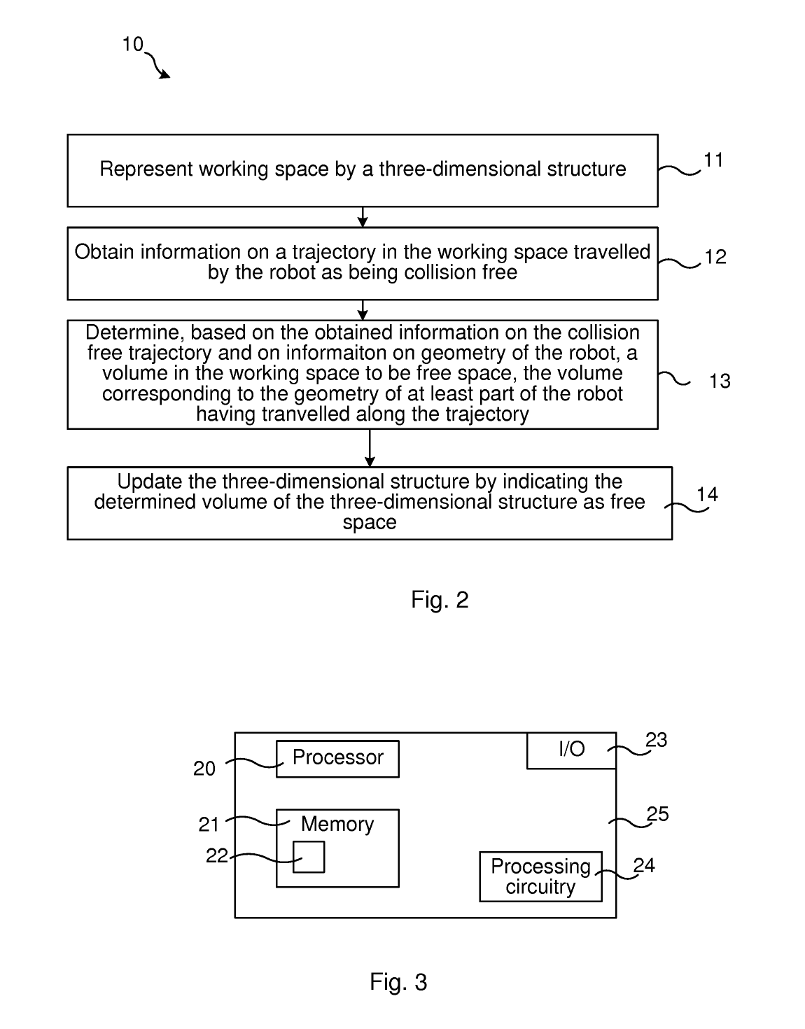

FIG. 2 is a flow chart over steps of an embodiment of a method in a control device 25 in accordance with the present invention.

The method 10 of building a geometric representation over a working space 1 of a robot 2 may be implemented and performed in a control device 25.

The method 10 comprises representing 11 the working space 1 by a three-dimensional structure. The three-dimensional structure may, for instance, be an octree representation of the working space 1. The octree representation is a recursive, hierarchical block representation. On the highest level, the entire working space 1 is covered by a single cube, which, according to the method 10, is initially marked as occupied space.

The method 10 comprises obtaining 12 information on a trajectory in the working space 1, travelled by the robot 2, as being collision free. The robot 2 moves or is moved along the trajectory (also denoted path). Such movement may, for instance, be accomplished by the end user manually moving the robot 2 within the working space 1. That is, the movements of the robot (the trajectory) can be given by lead-through programming, wherein the robot is programmed by being physically moved through the task by an operator. As another example, the movements of the robot can be pre-planned and programmed into a control device controlling the robot 2, i.e. by programming the robot 2 to autonomously move along a set of trajectories (the trajectories may alternatively be pre-programmed), the set comprising at least one trajectory. The movements during the learning phase can hence be anything from pre-programmed, camera-aided, lead-through programmed, or truly exploratory movements. The last option will typically only work for small robots, where the robot moves slowly as far as possible in different directions until a collision is found.

In some embodiments, or in combination with the already mentioned ways on obtaining 12 the information, the information obtained comprises information on previously executed and/or verified trajectories travelled by the robot 2.

The method 10 comprises determining 13, based on the obtained information on the collision free trajectory and on information on geometry of the robot 2, a volume in the working space 1 to be free space, the volume corresponding to the geometry of at least a part of the robot 2 having travelled along the trajectory. As a particular example on this, the robot 2 may move an arm along the trajectory. The robot arm, when moving from a starting point to an end point of the trajectory, does not collide with any object and information on the trajectory being collision free can therefore be registered. Based on the knowledge on the geometry of the robot arm its volume can be calculated, and knowing the trajectory along which the robot arm (the volume) moves, a certain volume V_{Free} can be determined as being free space. This can be repeated and the free space in which the robot can move without risking collisions can thereby be determined in a whittling or carving type of procedure.

The method 10 comprises updating 14 the three-dimensional structure by indicating the determined volume as free space in the three-dimensional structure.

In a preferred embodiment, the three-dimensional structure is implemented as an octree representation of the working space 1. The octree representation is a recursive, hierarchical block representation. On the highest level, the entire working space 1 is covered by a single cube, which is, as mentioned earlier, initially marked as occupied. Each cube can, if needed, be divided into eight smaller cubes, i.e. octants (hence, the name octree). The subdivision stops if a cube is known to be free or if a cube becomes smaller than a preset resolution, for example, 1 cm. That is, for each volume V_{Free} determined as free space, the subdivision stops. An advantage of this embodiment is that a minimized memory usage is obtained, since the number and size of the blocks in the octree structure is adapted automatically. This also saves processing capacity and processing time.

As is known, an octree is a tree data structure in which each node subdivides the space it represents into eight octants. The invention may, for instance, be implemented in any type of octree data structure. The octree model of the working space 1 gives a representation with cubes of different sizes, and the center of each cube (known as voxel) may be used as subdivision point. It is noted that the three-dimensional structure may be implemented in other ways as well, e.g. by using a triangle mesh for approximating boundaries of a swept volume.

In an embodiment, the method 10 comprises repeating the obtaining 12, determining 13 and updating 14 for a number N of trajectories, N being equal to or more than one. The more information on the working space 1 that is obtained the more accurate model thereof can be determined. Preferably, the number of trajectories should be selected such as to ensure that the working space 1 is sufficiently covered to give an accurate enough geometric representation over the working space 1. Many functions (e.g. collision prediction) rely on the geometric representation and any minimum requirements for such functions to work properly should be fulfilled.

In some embodiments, the obtaining 12 information comprises receiving information from at least one sensor arranged on the robot 2 and having moved from a start position to an end position of the trajectory. The robot 2 typically comprises a number of sensors, e.g. a respective axis position sensor arranged in each axis of the robot. Such axis position sensors may comprise an encoder type of sensor or a resolver type of sensor. The latter sensor, the resolver sensor, gives an x-value and a y-value (of the robots internal coordinate system), which may be recounted into an angle. These sensors may provide the required information.

In some embodiments, the method 10 comprises:
receiving information about the working space 1 from a camera 4, and
obtaining, based on the received information, a second three-dimensional representation of at least part of the working space 1.

The camera 4 may be mounted on the robot 2 and be arranged to perform a sweeping movement thereby giving a picture of the working space 1. The camera 4 may be a 3D camera giving the second three-dimensional representation in a known manner. In an embodiment, the above described approach is combined with the 3D camera 4. For example, if the robot 2 is holding the camera 4, the robot arm is usually behind the camera, which is an area that camera does not see. With this approach much of the area behind the camera 4 can also be marked as free space.

In a variation of the above embodiment, the method 10 comprises using the second three-dimensional representation for finding a trajectory in the working space 1 to be travelled by the robot 2. The second three-dimensional representation may alternatively, or in addition to finding trajectories, be used in combination with the model being created. The two representations may then be superimposed.

In various embodiments, the method 10 comprises obtaining information on a trajectory travelled by the robot 2 as encountering a collision, and indicating, based on the obtained information, a volume of the three-dimensional structure as occupied space. Typically all collisions should be avoided, e.g. since the environment in which the robot 2 moves (as well as the robot itself) may be fragile as well as expensive. However, the robot 2 may be programmed to move carefully, e.g. very slowly, and in such mode of operation collisions may be permitted. When the robot 2 encounters a collision, the surface involved in the collision may give some information on the obstacle that the robot 2 collided with. The size of the surface and a given thickness, preferably selected to be small since the obstacle is unknown, may be basis for calculating the volume of the three-dimensional structure that is occupied. This is thus an estimation of the occupied space, which estimation may be improved by means of the camera 4. For instance, if encountering a collision the camera 4 may be turned in that direction and give further information on the obstacle 3.

A robot 2 having a model of the working space 1 obtained by means of the method 10 may, for example, automatically plan a safe path to a restart position after a production stop. Other uses comprise real-time Collision Prediction and automatic planning of collision-free paths.

FIG. 3 illustrates schematically a control device and means for implementing embodiments in accordance with the present invention. The control device 25 may be a standalone device configured to perform any of the embodiments of the method 10, or it may be part of a known robot control system and used only for building the geometric representation over the working space 1.

The control device 25 comprises a processor 20 comprising any combination of one or more of a central processing unit (CPU), multiprocessor, microcontroller, digital signal processor (DSP), application specific integrated circuit etc. capable of executing software instructions stored in a memory 21 which can thus be a computer program product. The processor 20 can be configured to execute any of the various embodiments of the method 10 as described herein, for instance as described in relation to FIG. 2.

The memory 21 of the control device 25 can be any combination of read and write memory (RAM) and read only memory (ROM), Flash memory, magnetic tape, Compact Disc (CD)-ROM, digital versatile disc (DVD), Blu-ray disc etc. The memory 21 may also comprise persistent storage, which, for example, can be any single one or combination of magnetic memory, optical memory, solid state memory or even remotely mounted memory.

The control device 25 may comprise an interface 23 for communication with other devices and/or entities. The interface 23 may, for instance, comprise a protocol stack, for communication with other devices or entities. The interface may be used for receiving input data and for outputting data.

The control device 25 may comprise additional processing circuitry 24 for implementing the various embodiments according to the present invention.

The control device 25 may be configured to perform the steps of any of the embodiments described, e.g. with reference to FIG. 2. The control device 25 may be configured to perform the steps e.g. by comprising one or more processors 20 and memory 21, the memory 21 containing instructions executable by the processor 20, whereby the control device 25 is operative to perform the steps.

FIG. 4 illustrates an exemplary representation of an environment, in particular a robot base, when using the method 10 in accordance with the present invention. At start, the representation may, for instance, be a solid cube. As the environment is explored by means of the robot 2 space can be carved out from this initial representation. For each collision-free movement that the robot 2 makes, a space corresponding to the robot volume and the trajectory along which this volume is moved can be carved out as has been described. The robot base shown in FIG. 4 can, by means of the invention, be represented with great detail using an octree data structure.

In summary, the method according to the invention will make the robot aware of its surroundings. The created model will serve like a memory over places where the robot has been before so that it can remember which areas are free of collision. If the model is continually updated, it will be more and more refined.

The model can be used for Collision Prediction, and Collision-free path planning. An advantage is that that the user does need not have CAD-models of the environment, and there is no step where such CAD-models have to be converted to Collision-models. In a sense the robot learns its environment automatically.

The invention has mainly been described herein with reference to a few embodiments. However, as is appreciated by a person skilled in the art, other embodiments than the particular ones disclosed herein are equally possible within the scope of the invention, as defined by the appended patent claims.

1. A method of building a geometric representation over a working space of a robot, the method being performed in a control device and comprising:
representing the working space by a three-dimensional structure,
obtaining information on a trajectory in the working space travelled by the robot as being collision free,
determining, based on the obtained information on the collision free trajectory and on information on geometry of the robot, a volume in the working space to be free space, the volume corresponding to the geometry of at least a part of the robot having travelled along the trajectory, and
updating the three-dimensional structure by indicating the determined volume of the three-dimensional structure as free space.

2. The method as claimed in claim 1, comprising repeating the obtaining, determining and updating for a number N of trajectories, N being equal to or more than one.

3. The method as claimed in claim, wherein the obtaining information includes receiving information from at least one sensor arranged on the robot and having moved from a start position to an end position of the trajectory.

4. The method claimed in claim 1, further comprising:
receiving information about the working space from a camera, and
obtaining, based on the received information, a second three-dimensional representation of at least part of the working space.

5. The method as claimed in claim 4, comprising using the second three-dimensional representation for finding a trajectory in the working space to be travelled by the robot.

6. The method as claimed in claim 1, wherein the three-dimensional structure includes an octree data structure.

7. The method as claimed in claim 1, comprising obtaining information on a trajectory travelled by the robot as encountering a collision, and indicating, based on the obtained information, a volume of the three-dimensional structure as occupied space.

8. A computer program for a control device for building a geometric representation over a working space of a robot, the computer program including a computer program code, which, when executed on at least one processor on the control device causes the control device to perform a method comprising:
representing the working space by a three-dimensional structure,
obtaining information on a trajectory in the working space travelled by the robot as being collision free,
determing, based on the obtained information on the collision free trajectory and on information on geometry of the robot, a volume in the working space to be free space, the volume corresponding to the geometry of at least a part of the robot having travelled along the trajectory, and
updating the three-dimensional structure by indicating the determined volume of the three-dimensional structure as free space.

9. A computer program product comprising a computer program as claimed in claim 8 and a computer readable means on which the computer program is stored.

10. A control device for building a geometric representation over a working space of a robot, the control device being configured to:
represent the working space by a three-dimensional structure,
obtain information on a trajectory in the working space travelled by the robot as being collision free,
determine, based on the obtained information on the collision free trajectory and on information on geometry of the robot, a volume in the working space to be free space, the volume corresponding to the geometry of at least a part of the robot having travelled along the trajectory, and
update the three-dimensional structure by indicating the determined volume of the three-dimensional structure as free space.

11. The control device as claimed in claim 10, configured to repeat the obtaining, determining and updating for a number N of trajectories, N being equal to or more than one.

12. The control device as claimed in claim 10, configured to obtain the information by receiving information from at least one sensor arranged on the robot and having moved from a start position to an end position of the trajectory.

13. The control device as claimed in claim 10, configured to:
receive information about the working space from a camera, and
obtain, based on the received information, a second three-dimensional representation of at least part of the working space.

14. The control device as claimed in claim 13, configured to use the second three-dimensional representation for finding a trajectory in the working space to be travelled by the robot.

15. The control device as claimed in claim 10, configured to obtain information on a trajectory travelled by the robot as encountering a collision, and to indicate, based on the obtained information, a volume of the three-dimensional structure as occupied space.

16. The method as claimed in claim 2, wherein the obtaining information includes receiving information from at least one sensor arranged on the robot and having moved from a start position to an end position of the trajectory.

17. The control device as claimed in claim 11, configured to obtain the information by receiving information from at least one sensor arranged on the robot and having moved from a start position to an end position of the trajectory.
